(19) United States
(12) Patent Application Publication
(10) Pub. No.: US 2012/0036762 A1
(43) Pub. Date: Feb. 16, 2012

(54) QUICK CONNECT FISH HOOK AND FISHING SYSTEM

(76) Inventors: Ronald Alan Veith, Johannesburg, MI (US); Lukas Doyle Veith, Ovid, MI (US); Jakob Ronald Veith, Ovid, MI (US)

(21) Appl. No.: 13/207,126

(22) Filed: Aug. 10, 2011

Related U.S. Application Data
(60) Provisional application No. 61/401,297, filed on Aug. 11, 2010.

(51) Int. Cl. A01K 83/00; A01K 91/04

(52) U.S. Cl. 43/44.83

(57) ABSTRACT

A fish hook allows quick connection/disconnection to a fishing lure. A loop is formed and a tag portion extends beyond the contact point of the loop. The tag portion is inserted though a ring of a fishing lure. The contact point of the loop is sprung apart as the ring is slid onto the loop. When the ring is past the contact point the loop ‘snaps’ back into contact. In a second embodiment two opposing ‘j’ hooks are aligned forming an eye of the fish hook. A user applies force on the shafts supporting the ‘j’ hooks causing the two ‘j’ hooks to move in opposing directions and exposing the ends of the ‘j’ hooks. An end of one of the ‘j’ hooks is then inserted through a ring of a fishing lure. The ring is slid onto a shaft and the force released on the shafts released.

### CROSS REFERENCE TO RELATED APPLICATIONS

This application claims the benefit of the filing date of U.S. provisional application Ser. No. 61/401,297 entitled “TFT (Trouble Free Treble)” which was filed on Aug. 11, 2010 and which is incorporated herein by reference in its entirety.

### BACKGROUND OF THE INVENTION

The present invention relates primarily to fish hooks, fishing lures, and the like. More specifically, the present invention relates to an apparatus for quickly and easily attaching or detaching a fish hook to various fishing accessories including, but not limited to fishing lures, a loop of fishing line, and leaders.

For many generations fishing has been a sport and activity enjoyed by millions of people world wide. Further, the popularity of fishing is demonstrated by the amount of sales of fishing related items, and also the many fishing tournaments, some of which are even televised. As such, various types of fishing hooks, lures, and accessories have been introduced into the marketplace and the prior art provides many examples of these various devices including various lures, lure making kits, leaders, single fish hooks, treble fish hooks, and fish hooks of many shapes, sizes, and designs. The prior art also shows various examples of ways to attach fish hooks to lures and the like.

One problem with the current fishing technology is attaching and detaching hooks to/from fishing lures, fishing lines, bait, and other fishing gear. For example, many fishing lures have a ring by which the lure attaches to a fish hook. The user must carefully hold both the lure, the ring, and the hook while manipulating the eye of the hook onto the small ring of the lure. In some cases the user must use pliers, knives, magnifying glasses or other items to help them mount the hook onto the ring of the lure. This difficulty is likely a reason that fishing lures typically are sold with hooks pre-attached. A similar problem exists when a user attempts to remove a hook.

There exist several other problems related to the current art. One problem is safety. Fish hooks necessarily have sharp barbs. A user can easily be stabbed by these barbs while trying to attach/detach the hook. A other problem is cost. It is such an inconvenience to detach and attach hooks to a lure that some users merely throw away the entire lure and hook if the hook becomes damaged, rusted, or the like. A user would be inclined to keep a lure if the hook could easily be remove and a new one attached. Another cost related problem are scratches and damage to lures. Many lures are expensive. Lures are easily scratched or damaged by sharp fish hooks. This can happen when the lures are stored in a tackle box for example.

Finally, another problem relates to storage. Fishing gear can become tangled while in storage. Multiple fish hooks and lures can become tangled when they are not carefully separated. This frustration is alleviated when hooks are separated from a lure for storage.

With the high popularity of fishing, and leisure activities in general, many people are willing to spend hundreds or even thousands of dollars on fishing accessories. The accessories may include multiple types of fish hooks, lures, and the like. People desire to make their fishing experience as easy, trouble free, and enjoyable as possible. It is therefore advantageous to purchase accessories that permit a user to accomplish this end.

Accordingly, a need exists for new fish hooks and fishing systems that provide easily and quickly attaching and detaching of fishing hooks to lures, leaders, fishing line, bait, and the like. Similarly there is a need for new fish hook designs that accomplish this and are compatible with current fishing lures and devices. Such an apparatus would improve the enjoyment of the sport, reduce frustration, improve safety, and reduce costs. Therefore, an improved fish hook and fishing system that provide the aforementioned advantages is desired.

### SUMMARY OF THE PRESENT INVENTION

The aforementioned drawbacks and disadvantages of the prior fishing hooks and fishing lure systems have been identified and a solution is set forth herein by an inventive fish hook and fishing system which comprises a new fish hook with a unique attachment design. Two new fish hook embodiments are disclosed to facilitate the quick and easy attachment/detachment of the new fish hooks to/from fishing lures and the like. The embodiments have unique designs that allow them to easily snap onto a lure or the like.

One embodiment comprises a snap loop design. This design provides an extended tag portion that is inserted into the aperture of the ring of a fishing lure. Sufficient force is applied to move the ring of the fish lure past the contact point of the snap loop and couple with the snap loop. When the ring is moved past the contact point, the snap loop ‘snaps’ back into contact and hence the descriptive name ‘snap’ loop.

Another embodiment comprises two opposing ‘j’ hooks. Each ‘j’ hook is attached to a shaft. In the static condition the two ‘j’ hooks are aligned and form an eye of the hook. To attach this embodiment to a ring of a fishing lure, a user applies sufficient force on the two shafts to move the shafts towards each other. This force is envisioned to be easily applied using the thumb and a finger of one hand. This causes the two ‘j’ hooks to move away from each other. The ends of the ‘j’ hooks are now exposed and can be inserted through the aperture of the ring of the lure. Sufficient force is applied to slide the ring past the ‘j’ hook and contact point and onto the shaft. The force on the shafts is released and the two ‘j’ hooks move back to their aligned static position.

One feature of the present invention is the snap loop. The snap loop allows a fish hook to be easily attached to other fishing gear such as a fishing lure. The snap loop is attached near the head of the fishing hook. The snap loop is curved such that a tag portion of the loop contacts a first portion of the loop. The contact is maintained while the snap loop is in the static condition but contact may be interrupted by the application of force such as when attaching the hook to a lure. The snap loop is preferably made of memory wire or a material having memory characteristics such that when such a force is removed the snap loop returns to be in contact. The separation of the snap loop at the contact point permit's a ring of a fishing lure to be easily slipped onto the snap loop. Once the ring is past the contact point, the snap loop ‘snaps’ back into contact with the first portion of the snap loop. The ring and the snap loop are thus coupled.

Another feature of the present invention is a tag portion of the snap loop in contact with the head of the hook. The snap loop is made stronger and more secure by having the tag portion in contact with the head. In the event of a significant force exerted to separate the hook from the lure (such as may be caused by a hooking a large fish) the head of the shaft opposes movement of the tag portion and gives added rigidity to the snap loop.

Yet another feature of the present invention are duel opposing ‘j’ hooks. In the static condition the ‘j’ hooks are aligned and in contact such that the ‘j’ hooks and the attached shafts form an aperture, opening, or eye suitable for coupling with the ring of a fishing lure or the like. The ‘j’ hooks are moved in opposing directions by application of force on the shafts. This is preferably accomplished by simply squeezing the shafts using a thumb and a finger. When the ‘j’ hooks are displaced the ends of the ‘j’ hooks are exposed and can be inserted through a ring of a lure. The ring is then moved along the ‘j’ hook and onto the shaft.

Advantages of the invention include time savings. Using the invention, fish hooks are quickly attached or detached from a fishing lure. In addition, time is saved by reducing tangled lures and fishing gear. Since hooks are easily detached, the hooks and lures may be stored separately and thus reduce tangling. In addition, as the hooks are easily detached, the system now allows for increased lure storage (e.g., density) for any given space, as the lures can now be stored without the hooks being attached.

Another advantage is cost. Cost is reduced since expensive lures are not damaged or scratched by being stored with sharp hooks. Further, rusty or damaged hooks are easily removed and replaced and thereby extend the life of the lure.

Another advantage is safety. Fishing hooks necessarily have sharp barbs. The invention reduces the chance of injury by providing a quick, easy, and predictable way to attach and detach fishing hooks.

Another advantage is reduced aggravation and increased enjoyment. Many people are aggravated when a task such as attaching a fishing hook are difficult. People want to be fishing and not wasting time getting equipment or gear to operate. The invention reduces some of the aggravation by making it easier to attach and detach a fish hook and accomplish this without tools. Reducing aggravation and frustration correlates to more enjoyment of fishing.

Therefore, goals of the invention include ease of use, reduced cost, reduced aggravation and frustration, safety, and increased enjoyment of fishing.

To address the goals stated above, the inventive fish hooks and fishing system provide two embodiments. By solving the many difficulties associated with coupling hooks, lures, bait, and the like, the invention provides a cost effective way to address these problems for fishermen around the world. The invention is applicable to many fishing applications whether in a recreational setting, industrial setting, or for various sizes of hooks and lures.

Other objects, advantages, and features of the invention will become apparent upon consideration of the following detailed description, when taken in conjunction with the accompanying drawings. The above brief description sets forth rather broadly the more important features of the present disclosure so that the detailed description that follows may be better understood, and so that the present contributions to the art may be better appreciated. There are, of course, additional features of the disclosures that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. The fish hooks and fishing system of the present disclosure is capable of other embodiments and of being practiced and carried out in various ways. Also, it is to be understood that the phraseology and terminology employed herein are for description and not limitation.

As such, those skilled in the art will appreciate that the conception, upon which this disclosure is based, may readily be used as a basis for designing other structures, methods, and systems for carrying out the several purposes of the present invention. It is important, therefore, that the claims are regarded as including such equivalent constructions as far as they do not depart from the spirit and scope of the present invention.

Further, the purpose of the Abstract is to enable the U.S. Patent and Trademark Office and the public generally, and especially the scientists, engineers, and practitioners in the art who are not familiar with the patent or legal terms of phraseology, to learn quickly, from a cursory inspection, the nature of the technical disclosure of the application. Accordingly, the Abstract is intended to define neither the invention nor the application, which is only measured by the claims, nor is it intended to be limiting as to the scope of the invention in any way.

These and other objects, along with the various features, methods, and structures that characterize the invention, are pointed out with particularity in the claims annexed to and forming a part of this disclosure. For a better understanding of the present disclosure, its advantages, and the specific objects attained by its uses, reference should be made to the accompanying drawings and descriptive matter in which there are illustrated and described the preferred embodiments of the invention.

As such, while embodiments of the fish hook and fishing system are herein illustrated and described, it is to be appreciated that various changes, rearrangements and modifications may be made therein, without departing from the scope of the invention as defined by the claims.

### BRIEF DESCRIPTION OF THE DRAWINGS

As a compliment to the description and for better understanding of the specification presented herein, four pages of drawings are disclosed with an informative, but not limiting, intention.

FIG. 1 illustrates one embodiment of the invention showing a fish hook coupled to a fishing lure;

FIG. 2 illustrates a fish hook being attached to a fishing lure;

FIG. 3 illustrates a fish hook of the invention in detail;

FIG. 4a shows a cross section view of FIG. 3 illustrating the snap loop in the static position;

FIG. 4b shows a cross section view of FIG. 3 illustrating the snap loop separated such as when in the process of being coupled to a fishing lure;

FIG. 5 illustrates one preferred embodiment of the invention;

FIG. 6 illustrates a second embodiment of the invention;

FIGS. 7a and 7b illustrate the embodiment of FIG. 6 in the static position and in the open position for attaching to a fishing lure.

### DETAILED DESCRIPTION OF THE PREFERRED EMBODIMENT

The best mode for carrying out the invention is presented in terms of the preferred embodiment. Similar referenced characters designate corresponding features throughout the several figures of the drawings.

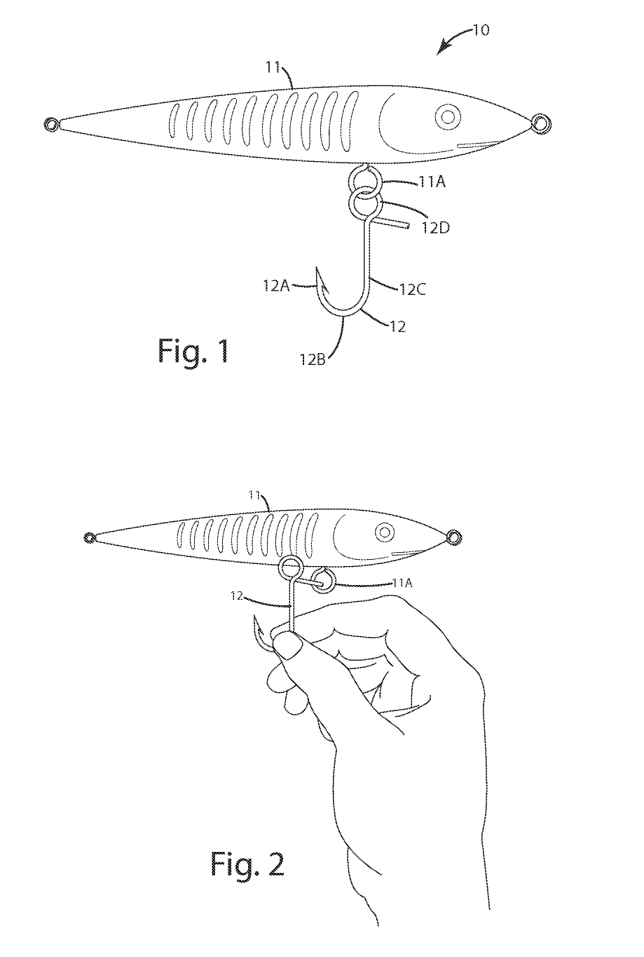

For purposes of description herein, the terms “left”, “right”, “top”, and ‘bottom” shall relate to the invention as oriented in FIG. 1 and viewed from above. However, it is to be understood that the invention may assume various alternative orientations, except where expressly specified to the contrary. It is also to be understood that the specific devices and methods illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference will now be made in detail to the present preferred embodiments of the invention, examples of which are illustrated in the accompanying drawings. Wherever possible, these same referenced numerals will be used throughout the drawings to refer to the same or like parts. Like features between the various embodiments utilize similar numerical designations. Where appropriate, the various similar features have been further differentiated by an alphanumeric designation, wherein the corresponding alphabetic designator has been changed. Further, the dimensions illustrated in the drawings (if provided) are included for purposes of example only and are not intended to limit the scope of the present invention.

An exemplary embodiment of the invention is shown in FIG. 1. While one preferred embodiment is a recreational size hook and lure, the invention is not meant to be so limited. Those skilled in the art will understand that the invention may be adapted to other size hooks and lures.

The components of the invention will first be briefly described and then described in detail. The fishing system 10 is comprised of a fishing lure 11 and fish hook 12. Lure 11 is merely representative of the nearly limitless types and sizes of lures that may be used in the invention. Lure 11 includes ring 11a for an attachment/coupling to a hook.

Hook 12 includes barb 12a, curved portion 12b, shaft 12c and snap loop 12d. Snap loop 12d encloses aperture 12e which is not an element of hook 12 but is useful to describe how ring 11a and snap loop 12d are linked. Throughout the specification terms linked, coupled, attached, and interlocked are used interchangeably to describe how the fish hooks of the invention are attached to rings, lures, and other fishing items.

Hencefore, one preferred embodiment will be described. However, this is merely for description and the size, proportions, indicia, and the like on hooks 12 and lures 11 may be changed to suit the particular requirements of the fishing environment and the desires of the users.

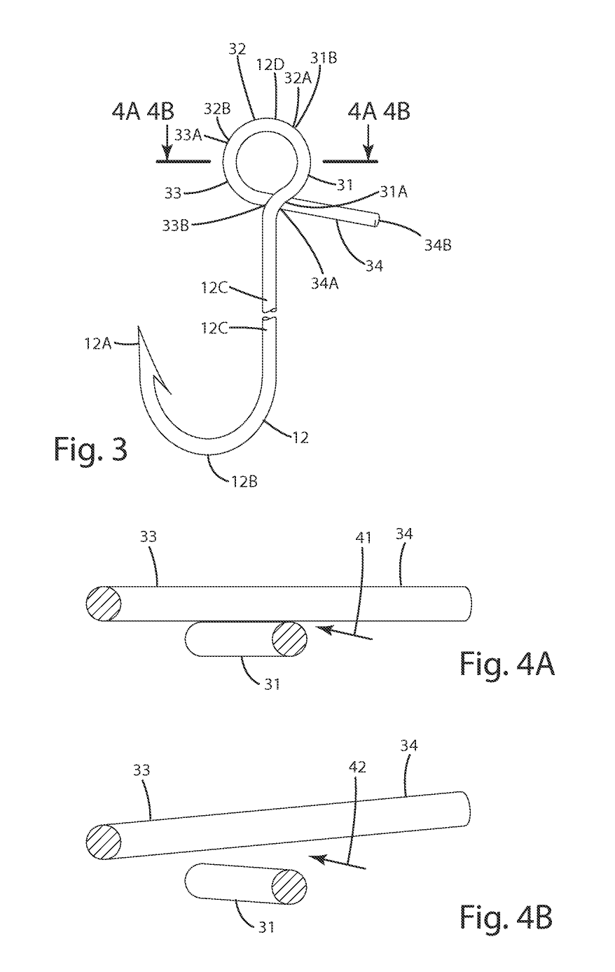

Referring now to FIG. 2, there is illustrated fish hook 12 being attached to lure 11. A user inserts the tag end 34b (see FIG. 3) of snap loop 12d through the aperture in ring 11a. The user applies sufficient force such that ring 11a and snap loop 12d are coupled as shown in FIG. 1. It should be understood that this coupling of snap loop 12d and ring 11a is accomplish easily and quickly by a user. The process of coupling snap loop 12d and ring 11a may be accomplish in as little as one or two seconds. Further, it is appreciated that coupling may be accomplished with a user's bare hands and without the necessity of other tools, pliers, or the like.

Referring now to FIG. 3, there is illustrated fish hook 12 of the invention in detail. Beginning with barb 12a, fish hook 12 will now be described in order to tag end 34b. Fish hook 12 includes Barb 12a, curved portion 12b, shaft 12c, and snap loop 12d. Snap loop 12d includes first loop portion 31, top loop portion 32, third loop portion 33, and tag portion 34. Shaft 12c is connected to the first end 31a of first loop portion 31. Continuing, second end 31b of first loop portion 31 connects to first end 32a of top loop portion 32. Second end 32b of top loop portion 32 connects to first end 33a of third loop portion 33. Second end 33b of third loop portion 33 connects to first end 34a of tag portion 34. Tag end 34b is inserted through aperture of ring 11a of lure 11 to begin attaching hook 12 to lure 11.

Referring to FIG. 4a, there is shown a cross section of snap loop 12d in the static position. In the static position, with no external forces applied, first loop portion 31 is in contact with tag portion 34. Snap loop 12d is preferably made using memory wire or a material with memory characteristics such that first loop portion 31 and tag portion 34 remain in contact in the absence of a force to separate them. The contact area is indicated by arrow 42. In the preferred size, tag portion 34 extends approximately ⅛ inch. It should be appreciated that tag portion 34 being in contact with first loop portion 31 helps to lock down or provide structural strength to snap loop 12d to prevent unwanted detachment. Snap loop 12d forms a closed loop that provides a reliable coupling with the ring 11a of a lure 11 or the like.

Referring now to FIG. 4b, there is shown a cross section of snap loop 12d when a force is applied to separate first loop portion 31 and tag portion 34. This is the condition when, for example, a ring from a lure 11 is being slid onto snap loop 12d. When such a force is applied, a gap indicated by arrow 42 is created which allows ring 11a to be moved past the contact area indicated by arrow 41.

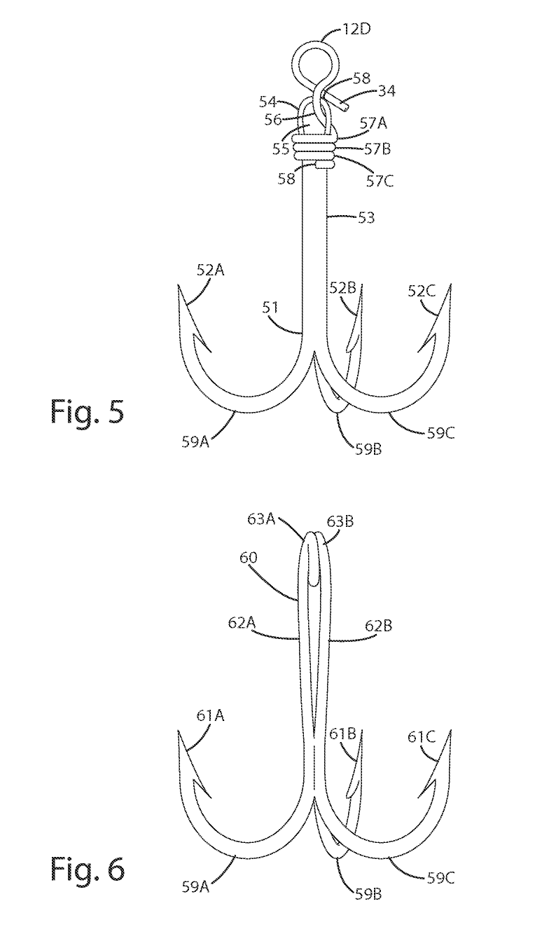

Referring now to FIG. 5, there is illustrated one preferred embodiment of the invention. In this embodiment snap loop 12d is secured to treble hook 51 by wrapping anchor portion 56 tightly around shaft 53 multiple times. Preferably approximately three windings 57a, 57b, and 57c are used to provide secure attachment of snap loop 12d to treble hook 51. Anchor portion 56 passes through eye 55 of treble hook 51. Tag portion 34 is in contact with head 54 of treble hook 51 at head contact point 58. The position of tag portion 34 in contact with head 54 provides added rigidity to the invention. Head 54 resists movement of tag portion 34 when force is applied to snap loop 12d. Also shown are conventional treble hook parts first barb 52a, second barb 52b, third barb 52c, first curved portion 59a, second curved portion 59b, third curved portion 59c. Anchor end 58 is also shown.

The preferred embodiment incorporates a snap loop 12d made of 195 lb. stainless steel wire with an eye of approximately ⅛ inch in diameter. Treble hook 51 is a short shank treble hook. The short shank treble hook 51 and snap loop 12d are together approximately 1 inch in length. This allows for attachment to almost all baits that would normally carry two or more hooks without tangling with each other. Treble hooks 51 that are too long allow hooks to get caught on each other on some small baits and lures. The preferred size hook is known as a size four. It is understood that the invention is also applicable to many other sizes of hooks.

Referring now to FIG. 6, there is illustrated an alternate embodiment of the invention. This embodiment had two moveable and opposing ‘j’ shaped parts to enable treble hook 60 to be attached/detached to a ring 11a of a fishing lure 11 or the like. In the static position first ‘j’ hook 63a and second ‘j’ hook 63b are aligned. ‘J’ hooks 63a and 63b are attached to moveable shafts 62a and 62b respectively. ‘J’ hooks are in contact with each other, but maybe slid in opposing directions by application of force on moveable shafts 62 as explained below. Also shown are barbs 52a, 52b, and 52c, and curved portions 59a, 59b, and 59c.

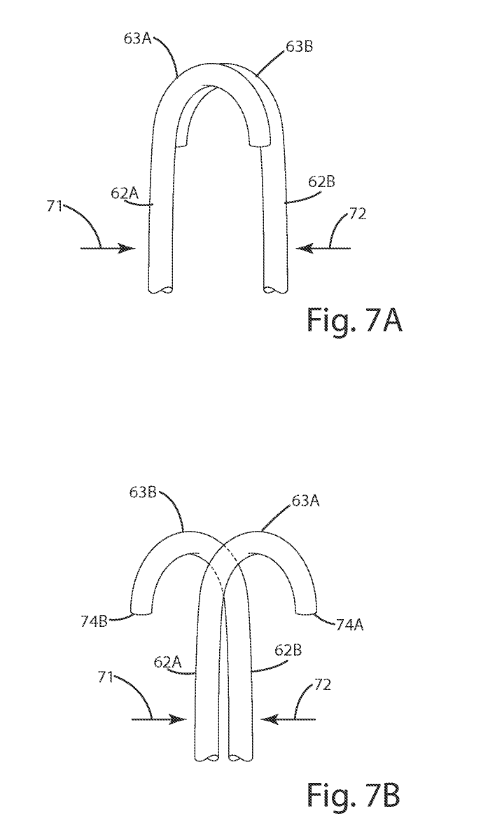

Referring now to FIGS. 7a and 7b, there is illustrated ‘j’ hooks 63 in the static position and in the displaced position respectively. In FIG. 7a, ‘j’ hooks 63a and 63b are aligned as they are in FIG. 6. Similarly, shafts 62a and 62b are separated as they are in FIG. 6. Arrows 71 and 72 indicate force that is applied to shafts 62 to move the shafts 62 closer together and to move ‘j’ hooks 63a and 63b in opposing directions. In operation it is intended that the force indicated by arrows 71 and 72 would be applied by a user's thumb and finger. However, pliers or other means may also be used to apply said force.

FIG. 7b illustrates the relative positions of ‘j’ hooks 63 and shafts 62 after the application of force indicated by arrows 71 and 72. Shafts 62 are now closer together and ‘j’ hooks 63 have been moved in opposing directions. ‘J’ hook ends 74a and 74b are now exposed. One of the ‘j’ hook ends 74 is inserted through the aperture of a ring 11a of a lure 11 to begin coupling hook 60 to a lure 11 or other fishing device. ‘J’ hook end 74 is inserted further through ring 11a until ring 11a is moved along ‘j’ hook 63 and then along shaft 62. It is understood that some force is required while moving ring 11a along ‘j’ hook 63 and shaft 62 since ‘j’ hooks 63 are in contact and must be forced apart sufficiently to allow ring 11a to move onto shaft 62. The user then releases forces 71 and 72 causing ‘j’ hooks 63 to return to the static position of figure 7a. Ring 11a is now coupled to fish hook 60.

Those skilled in the art understand that these examples are illustrative of the invention and that many other configurations of hook sizes, hook designs, and ring and lure designs can be extrapolated from these descriptions.

These descriptions illustrate the advantages of the invention. For example, the quick and easy attaching and detaching of the inventive fish hooks to/from lures. There is also the advantage that these tasks are accomplished without tools. The improvement in safety and the cost savings are also significant advantages. Finally, the advantage of reducing frustrating and therefore improving the enjoyment of fishing is apparent.

The specific configurations and features of the invention may vary according to specific requirements. In the preferred embodiment, the invention is generally used on treble hook about one inch in height. However, the invention may be adapted to various types of hooks and sizes. Further, although only a few embodiments of the invention have been illustrated, it is understood that many adaptations of the invention may be implemented without departing from the spirit of the invention.

The solutions offered by the invention disclosed herein have thus been attained in an economical, practical, and facile manner. To whit, a novel fishing hook and fishing system which is cost effective, easily adapted to most types of fishing gear, and quickly understood and appreciated by users has been invented. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurations disclosed herein are illustrative of the preferred and best modes for practicing the invention, and should not be interpreted as limitations on the scope of the invention as defined by the claims, and it is to be appreciated that various changes, rearrangements, and modifications may be made therein, without departing from the scope of the invention as defined by the claims.

1. A quick attach and detach fishing hook comprising:
a shaft;
a first barb;
a curved portion attached between said shaft and said first barb; and,
a snap loop having,
a first loop portion having,
a first end attached to said shaft, and,
a second end,
a top portion having,
a first end attached to said second end of said first portion, and,
a second end,
a third portion having,
a first end attached to said second end of said top portion, and,
a second end, and,
a tag portion having,
a first end attached to said second end of said third portion, wherein said first end is in contact with said first loop portion and extends from said first loop portion and is suitable for inserting through the aperture of a fishing device.

2. The quick attach and detach fishing hook according to claim 1 wherein said shaft includes,
a head and said tag portion is in contact with said head.

3. The quick attach and detach fishing hook according to claim 2 wherein said snap loop is made of a material with memory characteristics.

4. The quick attach and detach fishing hook according to claim 3 wherein said snap loop is made of memory wire.

5. The quick attach and detach fishing hook according to claim 2 wherein said snap loop includes,
anchor portion having,
a winding attached to said shaft by encircling said shaft.

6. The quick attach and detach hook according to claim 5 wherein said anchor portion passes through the eye of said head.

7. The quick attach and detach fishing hook according to claim 6 further comprising:
a second barb;
a third barb;
a second curved portion attached between said shaft and said second barb; and,
a third curved portion attached between said shaft and said third barb.

8. A snap loop fish hook comprising:
a hook, said hook having,
a barb end,
a shaft, and,
a curved portion connecting said barb end and said shaft; and,
a snap loop, said snap loop having,
a first loop portion having,
a first end mechanically attached to said shaft portion, and,
a second end,
a top loop portion having
a first end attached to said second end of said first loop portion, and,
a second end,
a third loop portion having,
a first end attached to said second end of said top loop portion, and,
a second end in contact with said first portion, and,
a tag portion extending from said first loop portion and suitable for inserting through the ring of a fishing lure, said tag portion having,
a first end attached to said second end of said third loop portion; and
wherein said snap loop includes an anchor portion attached to said first loop portion and attached to said shaft, said anchor portion having at least one winding.

8. (canceled)

9. The snap loop fish hook according to claim 8 wherein said hook includes,
A head attached to said shaft and defining an eye,
And where in said anchor portion passes through the eye of said head.

10. The snap loop fish hook according to claim 9 wherein said head is in contact with said tag portion.

11. The snap loop fish hook according to claim 10 wherein said snap loop is made of a material with memory characteristics.

12. The snap loop fish hook according to claim 11 wherein said snap loop is made of memory wire.

13. The snap loop fish hook according to claim 12 wherein said hook is a treble hook and includes:
a second barb end, and,
a third barb end.

14. A fishing system comprising:
a fish hook, said hook having,
a shaft,
a curved portion attached to said shaft,
a barb attached to said curved portion, and,
a snap loop, said snap loop having,
a first loop portion having,
a first end attached to said shaft, and
a second end,
a top portion having,
a first end attached to said second end of said first portion, and,
a second end,
a third portion having,
a first end attached to said second end of said top portion, and,
a second end proximate to said first end of said first portion, and,
a tag portion extending from said first end of said first portion and having,
a first end attached to said second end of said third portion; and,
a lure, said lure having,
a ring suitable for attaching to a fish hook, said ring coupled to said snap loop of said fish hook.

15. The fishing system according to claim 14 wherein said ring of said lure passes through the eye of said snap loop.

16. The fishing system according to claim 15 wherein said hook is a treble hook having,
a second curved portion attached to said shaft,
a second barb attached to said second curved portion,
A third curved portion attached to said shaft, and,
a third barb attached to said third curved portion.

17. The fishing system according to claim 16 wherein said shaft includes,
a head attached to the top of said shaft and wherein said head is in contact with said tag portion.

18. The fishing system according to claim 17 wherein said snap loop includes,
an anchor portion attached to said first end of said first loop portion for securing said snap loop to said shaft, said anchor portion having,
a winding that wraps around said shaft.

19. The fishing system according to claim 18 wherein said anchor portion passes through the eye of said head.

20. The fishing system according to claim 19 wherein said snap loop portion is made of memory wire.
